(19) United States
(12) Patent Application Publication
(10) Pub. No.: US 2026/0019829 A1
(43) Pub. Date: Jan. 15, 2026

(54) CELLULAR NETWORK OUTAGE MITIGATION

(71) Applicants: AT&T Intellectual Property I, L.P., Atlanta, GA (US); AT&T Mobility II LLC, Atlanta, GA (US)

(72) Inventors: Yusef Shaqalle, Minneapolis, MN (US); Kyung-Wook Hwang, Bedminster, NJ (US); Cecilia Nguyen, Hickory Creek, TX (US); Tanvi Alam, Roswell, GA (US); Weiyi Zhang, Edison, NJ (US); Slawomir Mikolaj Stawiarski, Carpentersville, IL (US); Shomik Pathak, Richardson, TX (US)

(73) Assignees: AT&T Intellectual Property I, L.P., Atlanta, GA (US); AT&T Mobility II LLC, Atlanta, GA (US)

(21) Appl. No.: 18/772,482

(22) Filed: Jul. 15, 2024

(51) Int. Cl. H04W 16/28; H04W 16/18; H04W 24/04; H04W 24/08

(52) U.S. Cl. CPC H04W 16/28; H04W 16/18; H04W 24/04; H04W 24/08

(57) ABSTRACT

Aspects of the subject disclosure may include, for example, detecting a service outage in a service area of a wireless network, assessing scope of the service outage according to a set of bins defined for the service area affected by the service outage, identifying one or more cells serving the set of bins for the service area affected by the service outage, identifying candidate cells to be reconfigured to serve the bins, selecting one or more candidate cells, forming selected cells, determining antenna tilts for each of the selected cells, the antenna tilts determined to provide coverage to bins of the set of bins for the service area affected by the service outage, and redirecting antennas of the selected cells according to the antenna tilts to compensate for the service outage at bins of the set of bins. Other embodiments are disclosed.

### FIELD OF THE DISCLOSURE

The subject disclosure relates to system and method for automating and improving or optimizing assessment and mitigation of cellular network outages.

### BACKGROUND

To ensure that a cellular network is always available, network engineers spend significant time trying to ensure that areas and users are still covered when an outage happens. Current solutions use timing advance (TA) information to identify which cells to use for mitigation of an outage.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system for identifying and mitigating a service outage in a cellular wireless network in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for assessing and mitigating service outages in a cellular wireless network or similar communications network. A service area of the network is divided into bins and network data is collected for each bin, including data such as signal strengths and numbers of signal receptions reported by user equipment (UE) active on the network in the area corresponding to a bin. In response to a network outage, data for each bin is examined to determine what cell sites serve the area including the bin, since adjacent cells may be designed for overlap. Based on signals received in the bins, candidate cells may be identified to provide service to the bin during the outage, until the outage is resolved. An artificial intelligence process or machine learning model identifies a set of cells and antenna tilt modifications to be made in the network to provide coverage to the bins to compensate for the service outage. Other embodiments are described in the subject disclosure.

One or more aspects of the subject disclosure include detecting a service outage in a service area of a wireless network, assessing a scope of the service outage, wherein the assessing is according to a set of bins defined for the service area affected by the service outage, identifying one or more cells serving each bin of the set of bins for the service area affected by the service outage, identifying candidate cells to be reconfigured to serve the bins of the set of bins for the service area affected by the service outage, selecting one or more candidate cells, forming selected cells, determining antenna tilts for each of the selected cells, the antenna tilts determined to provide coverage to bins of the set of bins for the service area affected by the service outage, and redirecting antennas of the selected cells according to the antenna tilts to compensate for the service outage at bins of the set of bins.

One or more aspects of the subject disclosure include receiving outage information about a wireless network, the outage information defining a service area affected by a service outage and one or more cells of the wireless network affected by the service outage, receiving bin information, the bin information including information about a set of bins defined for the service area affected by the service outage, identifying one or more cells serving each bin of the set of bins for the service area affected by the service outage, identifying candidate cells to be reconfigured to serve the bins of the set of bins for the service area affected by the service outage, selecting one or more candidate cells, forming selected cells; determining modifications to service areas of the selected cells, the modifications to the service areas determined to provide replacement coverage for the wireless network by the selected cells to bins of the set of bins for the service area affected by the service outage, and modifying the selected cells according to the modifications to compensate for the service outage at bins of the set of bins.

One or more aspects of the subject disclosure include determining, by a processing system including a processor, outage information about a service outage in a wireless network, the outage information defining one or more cells of the wireless network affected by the service outage, determining, by the processing system, bin information, the bin information including information about a set of bins defined for a service area of the wireless network affected by the service outage, identifying, by the processing system, one or more cells serving each bin of the set of bins for the service area affected by the service outage, identifying, by the processing system, candidate cells to be reconfigured to serve the bins of the set of bins for the service area affected by the service outage, selecting, by the processing system, one or more candidate cells, forming selected cells, and redirecting, by the processing system, antennas of the selected cells according to antenna tilts selected to provide coverage to bins of the set of bins for the service area affected by the service outage to thereby compensate for the service outage at bins of the set of bins.

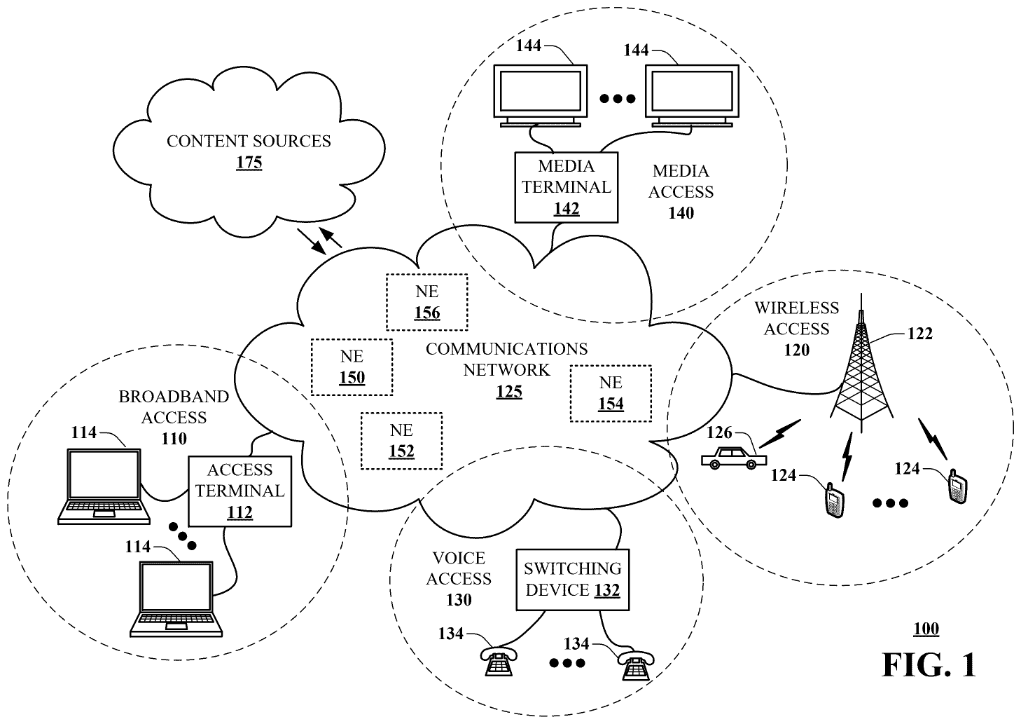

Referring now to FIG. 1, a block diagram is shown illustrating an example, non-limiting embodiment of a system 100 in accordance with various aspects described herein. For example, system 100 can facilitate in whole or in part responding to a service outage in a wireless network, including determining bin information for a service area affected by the service outage, assessing the service outage at the bin level including profiling signals received in the area corresponding to the bin, selecting one or more cells as candidates to serve the bin during the outage, receiving from a machine learning model a prediction for antenna tilts for a set of cells to compensate for the outage at the bin, and modifying antennas at adjacent cells according to the predicted antenna tilts. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

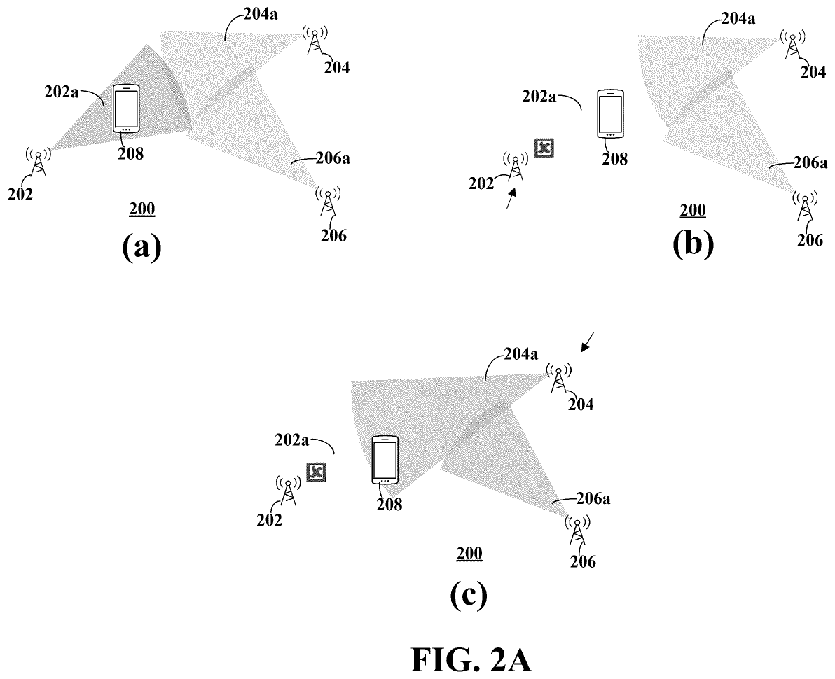

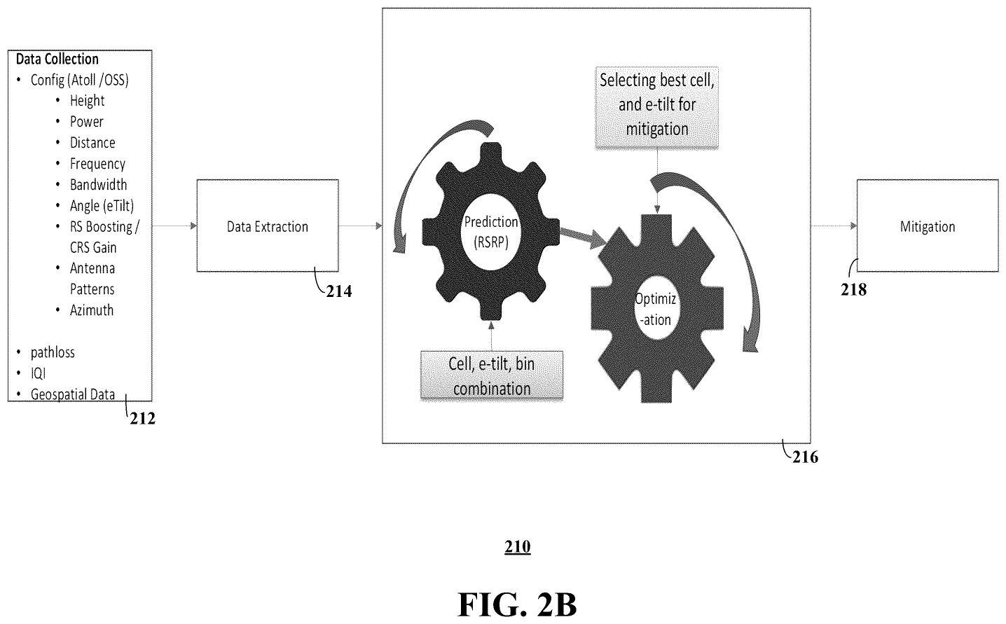

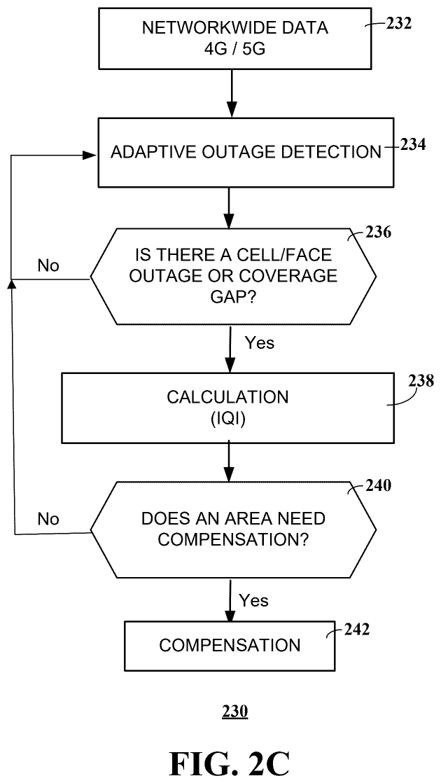

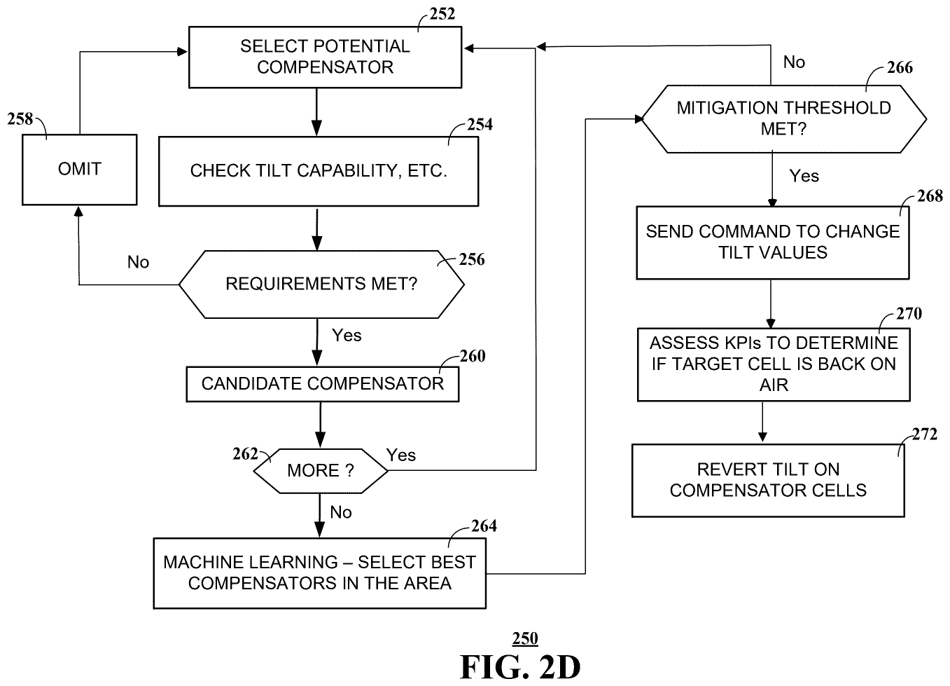

FIG. 2A is a block diagram illustrating an example, non-limiting embodiment of a system 200 functioning within the system 100 of FIG. 1 in accordance with various aspects described herein. In embodiments, the system 200 forms a portion of a cellular network or mobility network and may be, for example, part of wireless access 120 of FIG. 1.

In the exemplary embodiment, the system 200 includes three base stations including a first base station 202, a second base station 204 and a third base station 206. Each base station provides radio access to a coverage area. For example, base station 202 provides radio access to a coverage area 202a. Similarly, base station 204 provides radio access to a coverage area 204a and base station 206 provides radio access to a coverage area 206a. In general, each base station provides full coverage in a surrounding area around the base station. In this example, coverage provided to a single sector corresponding to approximately 120 degrees of azimuth is illustrated. A sector may also be referred to as a face or a face of an antenna.

Each respective base station may comprise any suitable equipment for providing mobile radio access to its respective coverage area. For example, each base station may include one or more eNodeBs or eNBs, one or more gNodeBs or gNBs, or other suitable devices for radio communication with user equipment (UE) such as UE 208. UE 208 may be any suitable user device such as a cellular phone, wireless phone, vehicle, internet of things (IoT) device, etc. The UE 208 is located in the coverage area 202a and communicates with the base station 202. Each respective base station may include backhaul communication equipment for data communication with other components of a mobility network, such as a core network. The core network (not shown) provides functions such as mobility management, authorization and accounting, etc.

Reliable network connectivity is extremely important to subscribers accessing the system 200. Subscribers depend on the mobility network to carry out daily connectivity activities such as work, shopping, and socializing, as well as critical needs like security and monitoring persons and property. However, unplanned network outages do occur, for many reasons. To ensure that the network is always available, network engineers spend significant time trying to ensure that areas and subscribers are still covered when an outage happens. In practice, cellular networks are designed for coverage and capacity and are typically over-provisioned; hence, cellular networks such as the system 200 have overlapping coverage that can be leveraged when some cell sites go down.

FIG. 2A (a) illustrates a normal operating condition. The three base stations, including base station 202, base station 204 and base station 206 are operating normally, providing radio access to their respective coverage areas, including coverage area 202a, coverage area 204a and coverage area 206a. UE 208 accesses the system 200 in coverage area 202a associated with base station 202. That is, UE 208 is attached to base station 202.

FIG. 2A (b) illustrates an outage condition. The base station 202 has failed and no longer provides service to the coverage area 202a, as indicated by the X adjacent to the base station 202 in the drawing figure. The UE 208 has lost service because no service is available in the coverage area 202a due to the service outage. However, as noted, because of deliberate overlaps among the coverage areas, adjacent cells may be used to mitigate the outage condition. The outage may affect the entire cell, or area surrounding the base station, or the outage may affect just a face or a sector or 120 degrees of azimuth (or in some embodiments other-sized sector) as illustrated in FIG. 2A (b). Further, in some technologies such as fifth generation (5G) cellular, the cell may transmit and receive on several different frequency bands. The outage may affect all frequency bands or just a subset of the frequency bands.

To find out which cells to use for mitigation, the conventional solution uses a timing advance (TA) metric to measure cell distances to the users. TA is the amount of time required for a mobile phone signal from the UE or other device to reach the base station. TA is used to synchronize timing for the UE and other devices in the system 200. Further, TA can determine how far from the base station or cell tower the UE is located. Knowing the distance from one cell base station, using such information as a proxy, enables determination of the intersection between possible overlapping cells. Then, an appropriate cell tilt of the antenna of an overlapped cell may be determined for mitigation.

Addressing a service outage may require two processes. A first process is identifying the coverage loss. A second process is mitigating the coverage loss. Conventionally, the network operator can identify the source of the coverage loss.

However, the conventional technique of using timing advance to determine the impact or scope of the loss has been insufficient. The current TA-based solution has two major concerns. First, traditional outage mitigation solutions apply stepwise electrical tilts to base station antennas. Such stepwise tilts only change the antenna tilt one degree out of time and rely on timing advance metrics. Such fixed change does not always generate the optimal solution for dynamic network situations. Moreover, fixed-degree tilts have been applied without considering if those tilts will be sufficient in fulfilling the coverage gaps created by an outage. For example, the traditional application will apply one-degree tilt changes every time the application detects an outage, even if no coverage gaps were created by the outage.

The other limiting factor is that TA is not a sufficiently accurate methodology to determine overlapping cells. Timing advance metrics only indicate how far a particular cell is serving and not the complete picture of the users' locations in a coverage area. To further complicate the issue, users are not uniformly distributed in a typical area that a particular cell site covers.

FIG. 2B is a block diagram illustrating an example, non-limiting embodiment of a system 210 for identifying and mitigating a service outage in a cellular wireless network in accordance with various aspects described herein. The system 210 includes a data collection module 212, a data extraction module 214, a measurement and quantification module 216 and a mitigation module 218. The system 210 may be implemented in any suitable manner by any suitable device associated with the cellular wireless network. In one example, the cellular wireless network includes a core network in data communication with cell sites. The cell sites form a radio access network (RAN) for radio communication with UEs operating on the cellular wireless network. The system 210 may be implemented on a processing system including one or more processors and memory for storing data and instructions. The system 210 may be implemented on a server or other data processing system of the core network, or at any other suitable location in data communication with facilities of the cellular wireless network.

Using data-driven automation and machine learning-based solutions, a solution in accordance with various aspects described herein provides an automated efficient, closed-loop solution to dynamically detect and improve network coverage holes. Once the areas are identified, the system and method provide recommendations for improvements with existing cell sites by changing the geometry of the cells. Further, the system and method may provide a mitigation percentage, or an indication of a likelihood of success or a proposed mitigation technique, or the effectiveness of the mitigation technique. Thus, the system and method give an assessment indication to the user, where the assessment indication provides information about a need to act to address a network outage. Further, the system and method give an assessment of the effectiveness of acting, such as a likely percentage improvement upon acting in the manner proposed.

One example change is a tilt change of an antenna at an adjacent cell. For example, the antenna may produce a beam for transmission or reception and the beam may be steered up or down. The beam may be steered down a few degrees or all the way to a minimum tilt of zero. Thus, in FIG. 2A (c), the system 200 has responded to the service outage at base station 202 by adjusting the antenna tilt on the antenna of base station 204. For example, the antenna may be tilted higher to extend the coverage area 204a associated with the base station 204 to include the area no longer served by out-of-service base station 202. UE 208 now is in the coverage area 204a and is able to connect to the base station 204.

In a system and method in accordance with various aspects described herein, a data-driven outage mitigation solution assesses, evaluates, and mitigates cellular wireless network outages at bin levels. In embodiments, a bin is a small square or rectangular area of a coverage area of the cellular wireless network. Other, non-rectilinear shapes may be used for each bin, but full-area coverage should be maintained. The bins and bin boundaries are defined in a database, data structure or other data processing element. The size of each bin can be selected by a user. The size, in general, can range from 1 meter to 1 kilometer on a side of each bin, although other dimensions may be used. Bin areas may in some applications be even larger areas as there are no limits on the upper bound. Bins may be defined in any suitable manner. An entire coverage area of the cellular wireless network may be defined by bins, or portions of the coverage area may be defined by bins.

As noted, cellular networks generally have overlapping coverage. That is, each bin in the coverage area may be served by more than one base station. This overlapping coverage can be leveraged when some cell sites go down.

Identification of the coverage loss may be achieved by analysis of key performance indicators for the cellular wireless network. In general, the cellular wireless network includes control functions that monitor operation in the network and evaluate information to identify and monitor network performance. One example KPI is data throughput, or how much data flows through a branch of the network per given time. Based on historical data, the network operator can identify normal operating conditions and abnormal operating conditions. In an example, when a portion of the network goes down, according to KPIs such as data throughput, the network operator can identify and locate the outage based on a variety of KPI values.

The data collection module 212 operates to collect and organize information about the cellular wireless network. The network information may include information about the configuration of the network and network elements, information about operation of devices in the network, and information about the environment around devices in the network. Any other suitable information may be collected, and the data collection module may operate on historical data collected over time as well as current and even real-time data.

In a first group of network information, the data collection module 212 collects information about configuration of network elements. Some examples are illustrated in FIG. 2B, and they include, for example, the height of an antenna at a cell site, frequencies of transmission and reception used by this outside, angle or tilt available to the antenna at the South side, antenna patterns and azimuth information.

Other examples of information collected at the data collection module 212 include information about operation of UE devices in the network. This may include path loss information for a UE as well as operational information. The UE information is associated with a physical or geographical location of the UE at a time when the information was measured or collected. For example, UE information may include measurements such as Reference Signal Received Power (RSRP), which is a measure of received signal strength for a signal received from a particular cell site or base station. It may be measured in dBm and have a value such as −95 dBm. Other examples of received and measured signals include Received Signal Strength Indicator (RSSI) and Reference Signal Received Quality (RSRQ). Further, the UE related information may include a count of a number of times the UE has received a signal such as a downlink control channel or a paging channel, from a particular base station. The information may be organized and stored at the base station or anywhere else suitable in the network. For example, the information may be stored according to UE identifier, base station identifier (which may be referred to as User Service identifier, or USID), RSRP value, and a count of number of signal receptions. Any other suitable information may be received, organized, reported and stored. The UE data may be termed and include IQI data in some examples, where IQI is a standard set of reported data from a UE.

The data collection module 212 further collects geospatial data about the environment around cell sites. For example, if UEs routinely report signal fading in a particular sector of face of a cell site, the data collection module 212 may conclude that coverage area served by the face is shielded or blocked by a permanent structure such as a building. By cross-correlating such information with similar information from other cell sites and UEs, the data collection module may develop a two-dimensional or three-dimensional understanding of the built environment or radio environment of each cell site in the cellular wireless network.

The data extraction module 214 operates to retrieve and process data collected by the data collection module 212. For example, the data extraction module 214 may select and organize data for ease of use and access by the measurement and quantification module 216. In the example embodiment, data is processed and organized according to bins. As noted, each bin is a relatively small rectangular portion of a coverage area of the cellular wireless network. The bin sized may be set or adjusted by a user, but a conventional size is 10 meters×10 meters. Location information collected and reported by UE devices, such as RSRP values, is correlated and associated with a bin according to a bin identifier. Thus, a bin may have an RSRP value of 95 dBm reported at a particular time. The measurement and quantification module 216 may operate on the network and UE data on a per-bin basis.

The measurement and quantification module 216 operates, as described further herein, to identify network outages based on the data collected by the data collection module 212 and processed by the data extraction module 214. Further, the measurement and quantification module 216 operates to identify candidate base stations or cells that will be used to fill gaps in coverage due to the outage. Still further, the measurement and quantification module 216 operates to select a cell site and tilt angle to mitigate effects of the outage in the cellular wireless network.

That is, first, the measurement and quantification module 216 may determine the bins and their coverage cell sites. The measurement and quantification module 216 examines network outages holistically, for example by inspecting outages at a bin level, which can be either 10 m×10 m or 100 m×100 m for example. The measurement and quantification module 216 can further profile cell site signals showing up in that bin. That is, the cell site signals are detected over time by a UE present in the location associated with and defined by the bin. Each bin most likely will be covered by, or receive signals from, multiple cells since the cellular wireless network is arranged with substantial overlap in coverage areas. Based on the number of records and signal quality (such as RSRP or other suitable value), the measurement and quantification module 216 then ranks the cells detected in each bin, as the top one cell is the current serving cell.

In embodiments, the measurement and quantification module 216 focuses on the bins where the outage cells are dominant (as a top one server) as these cells will be impacted once those cells go out of service. Dominant bins are further split into subcategories as some bins will have other cells providing coverage and which will have adequate coverage if the serving cells undergo an outage. The subcategories for the areas where impacted cells are dominant are as follows:
1. Bins where only the impacted cells are serving.
2. Bins that receive signals from other cells but do not have a good signal. In this case, a good signal may be determined based on an RSRP value, such as a value less than-110 dBm, or any other suitable value. The RSRP value may be adjustable by the user.
3. Bins that have other cells with a good signal, such as RSRP value greater than-110 dBm, or any other suitable value. Again, the RSRP value may be adjustable by the user.

Of these subcategories, subcategories labelled 1 and 2 are of concern for the outage application and these may be referred to as concern bins.

After determining the concern area, the measurement and quantification module 216 determines candidate cells or base stations that will be used to fill up the coverage gaps created by the cellular network outages. The candidates are selected based on cell interactions at the bin level. The measurement and quantification module 216 may rank cells based on the total number of bins that interact with the outage cells, for example. The users can choose how many cells the outage cells utilize as candidates by picking the top N cells from the interactions list, where N is an adjustable number.

Once the top N cells are selected, the measurement and quantification module 216 applies a machine learning module (MLM) or artificial intelligence (AI) process to determine custom tilts for each cell. The MLM or AI process identifies the best settings that will cover the concerned area. For each bin, the MLM or AI process can predict the RSRP in each BIN from each cell.

With the prediction from MLM or AI process, the measurement and quantification module 216 has a complete picture of the coverage map between bins and cells and antenna tilts. The measurement and quantification module 216 also has the information of usage, i.e., the number of users, at the bin level. Then the measurement and quantification module 216 forms the network mitigation problem into a combinatorial optimization problem and provides theoretically provable solutions to find out the best set of cell/tilt changes to optimize the network performance. The solution information may be provided to the mitigation module 218 which operates to communicate with cell sites and provide updated antenna tilt information to the cell sites. The tilt information is adopted, antennas and coverage is adjusted, and coverage is returned to the outage area through the other cell sites identified by the measurement and quantification module 216.

This optimization solution is also flexible for users. In an example, based on the user's preference, the solution can provide the satisfactory mitigation of the number of areas or numbers of users (traffic size) while using the minimum number of changes. In other examples, the solution can maximize the mitigation with a certain bound or number of cell and tilt changes. For example, the user can decide to recover 80% of the affected bins with the minimum number of changes. Or, the user can select to maximize the restored amount of users/traffic with minimal changes, or the user can select to provide maximum recovery with at most 20 changes.

FIG. 2C depicts an illustrative embodiment of a method 230 in accordance with various aspects described herein. The method 230 may be implemented in any suitable device such as a data processing system including one or more processors and memory and located, for example, in a core network of a cellular wireless network. In other embodiments, the method may be performed at a network element in data communication with network elements of the cellular wireless network such as base stations and located in any suitable location including located virtually in a server with network access.

The method 230 may be used to identify and assess a network outage in the cellular wireless network and compensate for the outage. There may be many reasons for the outage. There are many types of outages, including outage affecting the entire cell, outage affecting one face or sector of the cell or service area of the cell site, an outage affecting one or more frequency bands supported by the cell, etc. When a cell site goes down, there is a desire to modify one or more surrounding, neighbor cells to pick up the coverage loss and compensate for the outage. The neighbor cells compensate for the outage at the affected cell.

At step 232, the method 230 may include collecting data from a wide range of sources throughout the network. The data may include key performance indicator data (KPIs), this data may include current data representing current activity in the network as well as historical data representing network operations over a specified duration or time range. The data may be collected, or its location may merely be noted.

At step 234, an adaptive outage detection operation is performed. The method 230 is directed to identification and assessment of the coverage loss. Assessment includes determining what particular cell is down, how many cells are affected by the outage, what sectors are affected, what frequencies are affected, etc. The scope of the outage should be determined.

One process that may be included in adaptive outage detection includes monitoring a cell downtime for a particular cell. If a cell has been down or non-operational for a time exceeding a time duration threshold, such as 5 minutes of 30 minutes, step 234 may include determining if the cell has been manually or automatically disabled for some reason such as a planned maintenance operation. If an unplanned or other outage for the cell is detected, the cell is designated as a possible outage.

A second process that may be included in adaptive outage detection includes determination of a number radio resource control (RRC) attempts at each cell. When a UE seeks to attach to a cell, the UE communicates a message to the cell requesting a connection. Each such connection request is counted by the cell and reported to the network. In the example, if the cell has reported no RRC attempts within a predetermined time period, such as one hour, the cell is designated as a possible outage. Possible outage cells may be further evaluated, such as by analyzing bin data for the possible outage cell to further determine a scope of the outage.

In some embodiments, the scope of the outage that will be reported to a user or the network operator may be controlled by the user through inputs to a dashboard or user interface or other control mechanism. That is, the user may be given virtual knobs or controls to tailor outage detection to particular needs of the user. Some outages may be relatively insignificant in scope, or short in duration, and do not justify reporting and taking action.

For example, the user may be given the opportunity to specify the criteria that define an outage. One example criterion might be the amount of time that one or more cells have been down and not providing service to a customer. The user may be able to specify an outage duration threshold, such as 5 minutes or one hour. In an example, if an outage has only lasted 15 minutes, no outage is reported to the user. After 15 minutes, the system and method provide partial or full reporting, depending on user specification. Another example criterion might be types of impacts associated with an outage. For example, a threshold number of cell sites may be specified. If fewer sites are affected than is specified by the threshold number, the system and method may not report the outage to the user. The process of detecting an outage may be interactive by a user.

At step 236, the method 230 determines if an outage has occurred. An outage may be detected and located based, for example, on current KPI information. When an outage occurs, it is quickly reflected in KPI data. The outage is identified and related to a cell, or portion of a cell such as a face, as noted. If no outage is detected, control returns to step 234 to continue monitoring for an outage condition.

In an example embodiment, IQI data may be used to evaluate outage and the scope of an outage. IQI data may be collected from UEs as they operate in the network. Data such as RSRP values are reported by the UEs to the serving cell sites and in turn reported to, for example, components of the core network. IQI data may be used to assess current network performance. Historical IQI data may be used to evaluate network operation over time. IQI data may include collected values for RSRP, RSRQ, signal to noise ratio (SINR), receptions, indications of no service at a UE, indications that a UE is roaming, a distance indication, a measured transmit power for a physical uplink shared channel received at a base station or cell site, and a number of dropped voice calls.

If an outage is detected at step 236, control proceeds to step 238 to assess the scope of the outage. In exemplary embodiments, assessment is done on a bin level. As noted, service areas of the cellular wireless network may be assigned to bins having a specified size, such as 100 meters square. Each bin may be assigned an identifier and the location of the bin is known, as well as the cells which serve that bin. For example, a primary serving cell may be identified as the cell which primarily provides cellular radio connectivity to UEs when the UEs are located in the area defined by that bin. Further, one or more secondary cells which provide service to a UE located in the area associated with the bin may be identified and associated with the bin as well. The bin data may be previously processed and stored and retrieved for usage during the outage assessment operation. At step 238, the method 230 processes KPI data and any other suitable data for bins where the outage cells are dominant. Such bins will be impacted once those cells go out of service. Dominant bins are further split into subcategories as some bins will have other cells covering which will have adequate coverage if the serving cells undergo an outage.

In an embodiment, the outage may be determined based on a face indicator or face ID or a cell identifier of USID. The method 230 operates to identify bins covered by a specified face ID or USID. For those identified bins, the method locates other cells that provide service to the identified bins. The serving cells may then be ranked according to number of signal receptions and RSRP, or any other suitable data for the cell. Based on the ranking, the cells may then be split into two different groups or buckets, such as worry-free bins in which coverage provided by secondary cells is adequate, such as RSRP greater than-110 dBm or other threshold, and concerns bins. For example, the concerns bins may include those for which the only serving cell is an impacted cell bins that have secondary cells with an RSRP value below a threshold such as −110 dBm.

Stated differently, based on the bin data, subcategories may be developed for further analysis. The subcategories for the areas where impacted cells are dominant are as follows:

1. Bins where only the impacted cells are serving.

2. Bins that have other cells but do not have a good signal, which is determined by adjustable RSRP value less than-110 dBm, where RSRP corresponds to Reference Signal Received Power. This corresponds to bins which have a primary cell that is impacted but have a secondary cell that fails to exceed a threshold and thus may be considered to be a bad cell as well.

3. Bins that have other cells with a good signal, such as an (adjustable) RSRP value greater than-110 dBm.

In embodiments, bins in subcategories 1 and 2 are of particular concern for evaluating network outages and these may be termed concern bins. Other bins may be termed worry-free bins.

In an embodiment, a coverage gap may be defined as a ratio of a number of concerns bins to a number of outage cells. If the coverage gap exceeds a threshold, such as 10 percent of bins in an area, the method 230 may determine compensation is required. The threshold may be selectable or programmable by the user for a particular area or portion of the network, or for the entire network.

In some embodiments, based on the percentage of coverage gaps created by the outage, a user or network operator can decide the outage level that is acceptable. For example, the user can decide only to trigger the mitigation process when more than 90% of the areas are affected. Similarly, the user has the flexibility of the acceptance criteria for the mitigation solutions.

At step 240, the method 230 determines if an area requires compensation. Compensation is a process of redirecting other cells to provide temporary coverage to an area during an outage of one or more cells normally serving that area. Any suitable technique may be used to determine if the area requires compensation. Compensation may include, for example, altering antenna tilt at another cell that provides secondary coverage to a bin and which is unaffected by the outage. At step 242, a compensation process may be initiated.

FIG. 2D depicts an illustrative embodiment of a method 250 in accordance with various aspects described herein. The method 250 is directed to identifying a compensator or designated cell that will provide compensation for an outage at one or more affected bins defined for a coverage area. The compensator will provide cellular service coverage to bins of the affected area until the outage is resolved.

In embodiments, one or more compensators can be selected using subcategory 2 identified above, or bins that have other cells but do not have a good signal. As note, this subcategory corresponds to bins which have a primary cell that is impacted but have a secondary cell that fails to exceed a threshold and thus may be considered to be a bad cell as well. The secondary cells are candidates to be compensators. In addition, the candidates must meet additional criteria as well before selection as compensators for the outage.

At step 252, a potential compensator is selected. For example, the potential compensator is selected from a set of cell sites that are physically located and technically capable of providing cell service to one or more bins in an outage area. The potential compensator should be located in an area where the antenna of the potential compensator web site may provide service to the coverage area defined by one or more bins. The cell site should provide necessary cellular wireless service, such as 4G cellular, 5G NR cellular, 5G standalone (SA) cellular including all necessary frequency bands, etc. The potential compensators may form a set of potential compensators to be evaluated in the method 250. At step 252, a first potential compensator is selected for evaluation from the set.

At step 254, the method 250 retrieves and analyzes information about the capability of the potential compensator to provide the necessary compensation to the bins in the outage area. For example, step 254 may include determining if the antenna of the potential compensator is functional and can be steered and determining if the antenna is currently at a minimum or maximum tilt angle. Generally, tilt angles extend from 0 degrees to 15 degrees. For example, if the antenna is at a 0 degree tilt angle and can't be tilted further to provide the necessary compensation, the potential compensator should be ruled out. In embodiments, the processing system performing steps of the method 250 may synchronize with an operations support function of the cellular wireless network to obtain latest status and operational information for the potential compensator.

At step 256, the method 250 determines if all requirements for a compensator are met by the potential compensator. For example, the required frequency range is verified; signal measurements such as RSRP are verified to ensure that the potential compensator will perform as required if selected. If requirements are not met, the potential compensator is omitted from the set and from further consideration, step 258. On the other hand, if requirements are met, the potential compensator is designated a candidate compensator, step 260. In some embodiments, a top N potential compensators are selected as candidates, where N is any suitable number and may be controlled by a user such as the network operator.

At step 262, the method 250 determines if there are more potential compensators in the set. If so, control returns to step 252 to evaluate the next potential compensator in the set. If not, the set of candidate compensators is provided to a machine learning (ML) model or artificial intelligence (AI) module to select one or more best compensators in the area.

In embodiments, the ML model or AI module operates to determine custom tilts for each cell to determine the best settings that will cover the concerned service area. The ML model has awareness of the coverage area for each cell and available tilts for each cell. For each bin, the ML model or AI module can predict the RSRP in each bin from each cell. The ML model or AI module may operate to determine, for each cell that has room to tilt, a best tilt value that gives the best coverage and best signal quality at the bins corresponding to the outage area.

Moreover, the ML model operates on multiple frequencies so that a different frequency band may be identified as the best compensator. Still further, the ML model may have access to geospatial information about terrain and the built-up environment such as structures, and can simulate the effects of the environment on coverage possibilities.

In another example, the ML model may take into account the distribution of subscribers among the bins being analyzed. One bin may have many more subscribers with UEs attached to the network than another bin. If the two bins are equal, the ML model may optimize for the bin with a larger distribution of subscribers. In some examples, coverage may be moved from a lightly populated bin to a more heavily populated bin.

In another example, the ML model may take into account the presence of and distribution of first responders who require communication access to the cellular wireless network. The occurrence of a service outage may correlate with another emergency situation that requires first responders such as police and fire and other emergency personnel. In an embodiment, during an emergency, the ML model could identify areas in which there are a relatively high population or concentration of first responders and adjust antenna tilts accordingly to provide improved service during the duration of the outage to the first responders. Any suitable information available in the network may be used to identify the first responders, such as quality of service (QOS) Class Identifier (QCI) or 5QI values or geotags associated with the first responders. If the service outage cannot be mitigated for all users, some users may be prioritized based on any suitable factors or available data.

In one example, the ML model employs a Bayesian optimization. However, other model types may be used as well, such as reinforcement learning.

The result may be a list of cells that can be optimized, for example by adjusting the antenna tilt of the cell. Tilt may be adjusted electronically. In other embodiments, the ML model or AI module may operate to optimize any parameter or operating condition of interest in order to compensate for or overcome the service outage. Identifying compensating cells and antenna tilt values is one particular exemplary embodiment.

Based on the prediction from machine learning or artificial intelligence, the method 250 has a complete picture of the coverage map between bins and cells, along with associated antenna tilts for the cells. The method 250 also has the information on usage, such as the number of users, at the bin level. Conventional solutions have lacked this information or failed to utilize this information. In embodiments, the network mitigation problem may be formed into a combinatorial optimization problem and thus provide theoretically provable solutions to find out the best set of cell/tilt changes to optimize the network performance.

At step 266, based on the proposed network changes developed by the ML model or AI process, the method 250 determines if a mitigation threshold is met. In one example, the outage may have created a coverage gap in which some percentage of users no longer have coverage, such as 20% in the network. Step 266 provides for determining how many of those users will regain coverage given the proposed solution. If a substantial network modification is required to regain coverage for only one percent of users, the modification may not be justified. In another example, the proposal developed by the ML model or AI process may improve some conditions or some aspects at some bins in the coverage area. However, due to severity or widespread nature of the outage, the solution may be inadequate to satisfy, for example, network KPIs. Thus, the process of step 266 is an operation of determining, we have a solution, should we implement that solution? In some embodiments, the process of step 266 may be interactive with a user or network operator personnel. For example, details about the current outage and the proposed solution may be presented at a dashboard or other user interface and the user may be given options to proceed. If the solution is not satisfactory, flow may be returned to step 252 to begin to develop another solution.

If the solution is satisfactory at step 266, control proceeds to step 268. At step 268, a command is sent to modify antenna tilt values and any other operational features determined to be appropriate, by the ML model or any other process. In an example, a network operations center provides control functions for the overall cellular wireless network and can provide necessary commands to remote network elements such as cell sites to modify functional parameters such as antenna tilts.

At step 270, the method 250 includes monitoring the outage to determine if the outage continues. This may be done in any suitable manner, such as monitoring appropriate KPIs for the network. The KPIs serve to give status information about network elements such as the cell site subject to the outage. If the KPIs indicate that the outage continues, no change may be made. On the other hand, if the KPIs indicate that the outage has been corrected, at step 272, modifications made to accommodate the outage may be reversed to return the network to a nominal state. In the example, the modified tilt applied to the cell site antennas to provide coverage to affected bins in the coverage area may be returned to a normal tilt value.

In embodiments, once an outage has been identified, the process of assessing the outage, developing a solution and sending commands to modify the network may take on the order of 1 to 5 minutes, or even less than one minute, to accomplish. Response to the network outage can be accomplished very quickly.

While for purposes of simplicity of explanation, the respective processes are shown and described as a series of blocks in FIG. 2C and FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

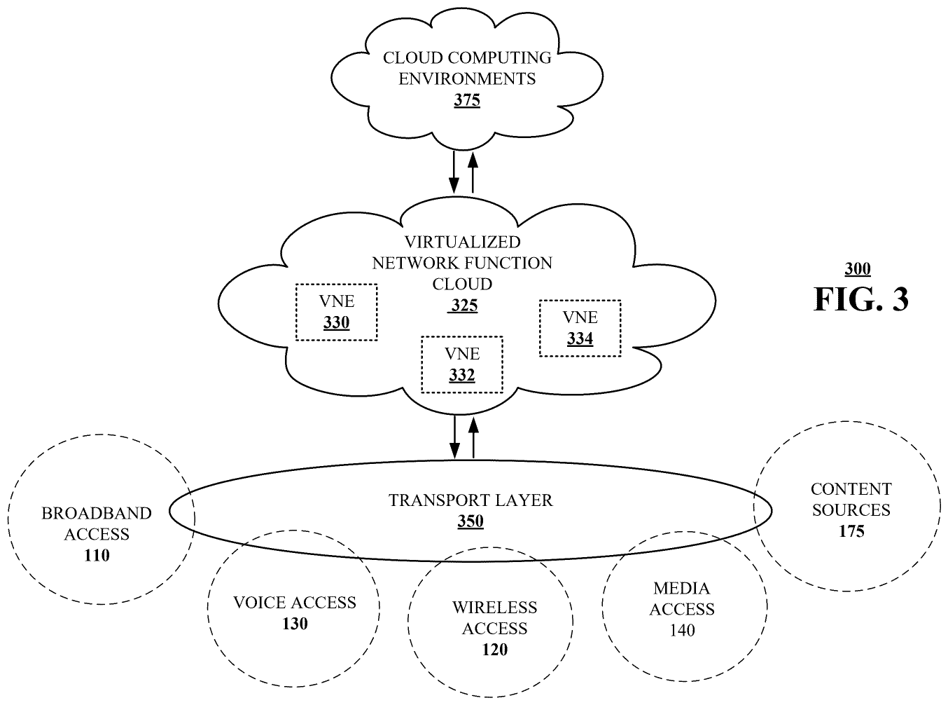

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, and method 230 presented in FIG. 1, FIG. 2A, FIG. 2B, FIG. 2C, FIG. 2D, FIGS. 2E and 3. For example, virtualized communication network 300 can facilitate in whole or in part responding to a service outage in a wireless network such as the wireless access 120, including determining bin information for a service area affected by the service outage, assessing the service outage at the bin level including profiling signals received in the area corresponding to the bin, selecting one or more cells as candidates to serve the bin during the outage, receiving from a machine learning model a prediction for antenna tilts for a set of cells to compensate for the outage at the bin, and modifying antennas at adjacent cells according to the predicted antenna tilts.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

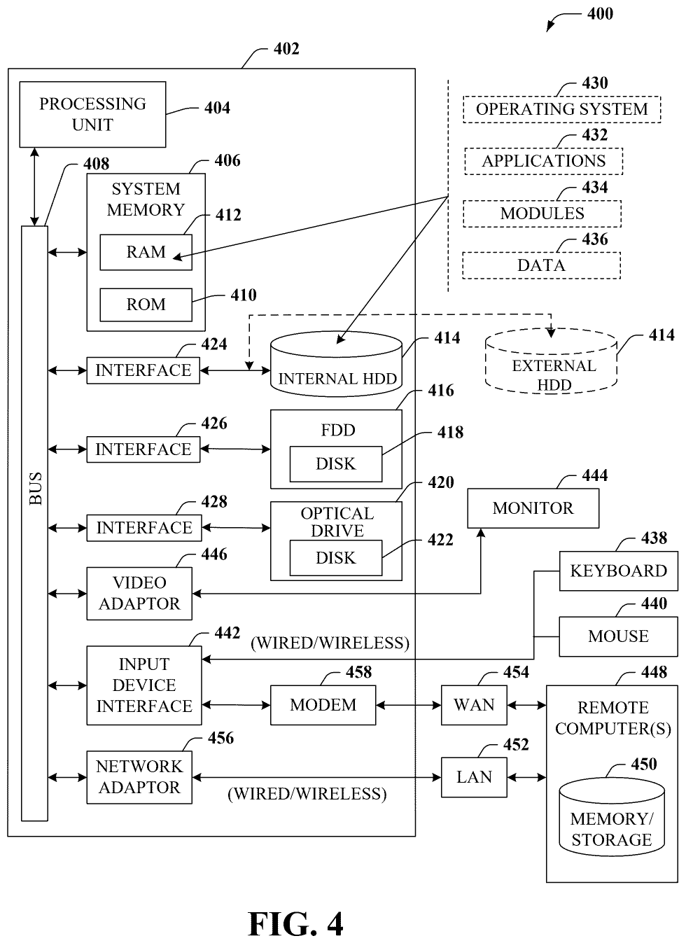

Turning now to FIG. 4, there is illustrated a block diagram of a computing environment 400 in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part responding to a service outage in a wireless network, including determining bin information for a service area affected by the service outage, assessing the service outage at the bin level including profiling signals received in the area corresponding to the bin, selecting one or more cells as candidates to serve the bin during the outage, receiving from a machine learning model a prediction for antenna tilts for a set of cells to compensate for the outage at the bin, and modifying antennas at adjacent cells according to the predicted antenna tilts. For a network operator, a dashboard or similar user interface may be presented at the computing environment 400 for viewing network data and controlling network operation.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

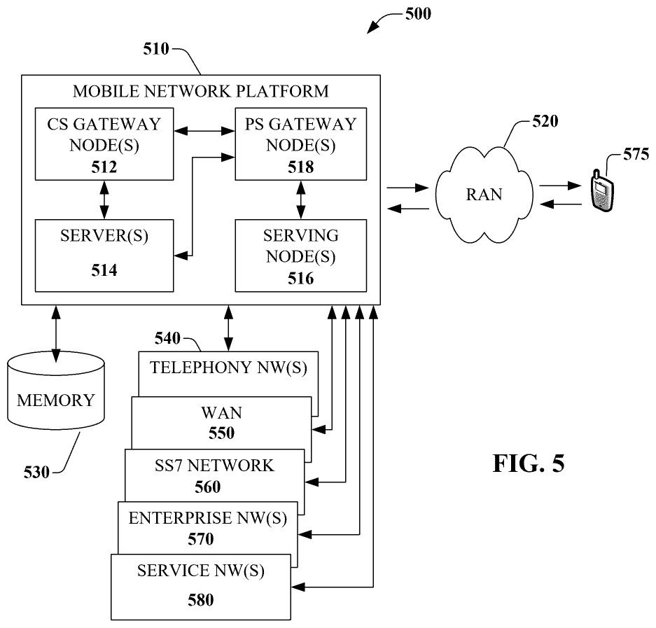

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part responding to a service outage in a wireless network which may include or be in communication with the platform 510, including determining bin information for a service area affected by the service outage, assessing the service outage at the bin level including profiling signals received in the area corresponding to the bin, selecting one or more cells as candidates to serve the bin during the outage, receiving from a machine learning model a prediction for antenna tilts for a set of cells to compensate for the outage at the bin, and modifying antennas at adjacent cells according to the predicted antenna tilts. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

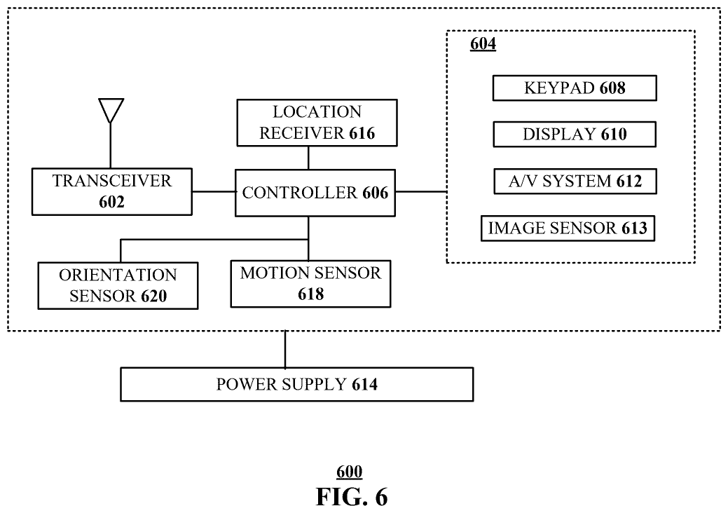

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part responding to a service outage in a wireless network on which the communication device 600 may operate, including determining bin information for a service area affected by the service outage, assessing the service outage at the bin level including profiling signals received in the area corresponding to the bin, selecting one or more cells as candidates to serve the bin during the outage, receiving from a machine learning model a prediction for antenna tilts for a set of cells to compensate for the outage at the bin, and modifying antennas at adjacent cells according to the predicted antenna tilts.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
detecting a service outage in a service area of a wireless network;
assessing a scope of the service outage, wherein the assessing is according to a set of bins defined for the service area affected by the service outage;
identifying one or more cells serving each bin of the set of bins for the service area affected by the service outage;
identifying candidate cells to be reconfigured to serve the bins of the set of bins for the service area affected by the service outage;
selecting one or more candidate cells, forming selected cells;
determining antenna tilts for each of the selected cells, the antenna tilts determined to provide coverage to bins of the set of bins for the service area affected by the service outage; and
redirecting antennas of the selected cells according to the antenna tilts to compensate for the service outage at bins of the set of bins.

2. The device of claim 1, wherein the assessing the scope of the service outage comprises:
profiling cell signals which are present in each bin of the set of bins.

3. The device of claim 2, wherein the profiling cell signals comprises:
retrieving signal strength information about signals from the one or more cells serving each bin of the set of bins received at each bin of the set of bins;
for each bin of the set of bins, ranking cells of the one or more cells serving the bin; and
identifying a top ranked cell as the cell serving the bin.

4. The device of claim 3, wherein the operations further comprise:
identifying cells affected by the service outage, forming affected cells; and
identifying bins in which the top ranked cell is an affected cells of the affected cells, forming dominant bins.

5. The device of claim 4, wherein the operations further comprise:
identifying one or more first bins in which only a single affected cell serves a bin, forming a first set of bins;
identifying one or more second bins in which more than one affected cell serves the bin, but affected cells have signal strength information that does not exceed a signal strength threshold value, forming a second set of bins; and
ranking cells of the affected cells based on a total number of bins of the first set of bins and the second set of bins that interact with the affected cells, forming ranked cells; and
selecting N ranked cells as the candidate cells, where N is a selectable number of cells.

6. The device of claim 1, wherein the determining antenna tilts for each of the selected cells comprises:
providing information about the set of bins for the service area affected by the service outage and the one or more candidate cells to a machine learning model; and
receiving, from the machine learning model, prediction information for each bin of the set of bins, the prediction information including the antenna tilts for each of the selected cells and a predicted signal strength for the bin.

7. The device of claim 6, wherein the operations further comprise:
determining a best set of selected cells and a best antenna tilt for each selected cell of the best set of selected cells to optimize performance of the wireless network.

8. The device of claim 7, wherein the operations further comprise:
retrieving information about a number of users at each bin of the set of bins for the service area affected by the service outage; and
determining the best set of selected cells and a best antenna tilt for each selected cell of the best set of selected cells based on the prediction information for each bin of the set of bins and the information about the number of users at each bin.

9. The device of claim 1, wherein the operations further comprise:
retrieving information about a number of users at each bin of the set of bins for the service area affected by the service outage; and
redirecting antennas of the selected cells according to the antenna tilts according to the antenna tilts and the information about the number of users at each bin.

10. The device of claim 1, wherein the operations further comprise:
providing, to a network operator of the wireless network, a dashboard, the dashboard configured to present, to the network operator, information about the service outage, information about the service area affected by the service outage, and to receive, from the network operator, selection information to tailor a response to the service outage.

11. A non-transitory machine-readable medium, comprising executable instructions that, when executed by a processing system including a processor, facilitate performance of operations, the operations comprising:
receiving outage information about a wireless network, the outage information defining a service area affected by a service outage and one or more cells of the wireless network affected by the service outage;
receiving bin information, the bin information including information about a set of bins defined for the service area affected by the service outage;
identifying one or more cells serving each bin of the set of bins for the service area affected by the service outage;
identifying candidate cells to be reconfigured to serve the bins of the set of bins for the service area affected by the service outage;
selecting one or more candidate cells, forming selected cells;
determining modifications to service areas of the selected cells, the modifications to the service areas determined to provide replacement coverage for the wireless network by the selected cells to bins of the set of bins for the service area affected by the service outage; and
modifying the selected cells according to the modifications to compensate for the service outage at bins of the set of bins.

12. The non-transitory machine-readable medium of claim 11, wherein the operations further comprise:
retrieving signal strength information about signals from the one or more cells serving each bin of the set of bins received at each bin of the set of bins;
for each bin of the set of bins, ranking cells of the one or more cells serving the bin according to the signal strength information;
identifying a top ranked cell as the cell serving the bin; and
identifying other serving cells serving the bin.
ranking cells according to the top ranked cell and the other serving cells, wherein the ranking is based on a total number of bins that affect with the top ranked cell and the other serving cells, forming ranked cells; and
selecting N ranked cells as the candidate cells, where N is a selectable number of cells selectable by an operator of the wireless network.

13. The non-transitory machine-readable medium of claim 11, wherein the determining modifications to service areas of the selected cells comprises:
determining antenna tilts for each of the selected cells, the antenna tilts determined to provide coverage to bins of the set of bins for the service area affected by the service outage.

14. The non-transitory machine-readable medium of claim 11, wherein the determining antenna tilts for each of the selected cells comprises:
providing information about the set of bins for the service area affected by the service outage and the one or more candidate cells to a machine learning model; and
receiving, from the machine learning model, prediction information for each bin of the set of bins, the prediction information including information about antenna tilts for each of the selected cells and a predicted signal strength for the bin.

15. The non-transitory machine-readable medium of claim 14, wherein the operations further comprise:
retrieving information about a distribution of users among bins of the set of bins for the service area affected by the service outage; and
determining a best set of selected cells and a best antenna tilt for each selected cell of the best set of selected cells based on the prediction information for each bin of the set of bins and the information about the distribution of users at each bin.

16. A method, comprising:
determining, by a processing system including a processor, outage information about a service outage in a wireless network, the outage information defining one or more cells of the wireless network affected by the service outage;
determining, by the processing system, bin information, the bin information including information about a set of bins defined for a service area of the wireless network affected by the service outage;
identifying, by the processing system, one or more cells serving each bin of the set of bins for the service area affected by the service outage;
identifying, by the processing system, candidate cells to be reconfigured to serve the bins of the set of bins for the service area affected by the service outage;
selecting, by the processing system, one or more candidate cells, forming selected cells; and
redirecting, by the processing system, antennas of the selected cells according to antenna tilts selected to provide coverage to bins of the set of bins for the service area affected by the service outage to thereby compensate for the service outage at bins of the set of bins.

17. The method of claim 16, comprising:
determining, by the processing system, cell signals from serving cells which serve each bin of the set of bins; and
profiling, by the processing system, the cell signals according to a number of cell signals detected at each bin and according to signal strength of the cell signals detected at each bin.

18. The method of claim 17, comprising:
identifying, by the processing system, first bins served only by cells affected by the service outage;
identifying, by the processing system, second bins served by cells affected by the service outage and served by cells having a signal strength at the bin exceeding a signal strength threshold; and
identifying, by the processing system, the candidate cells based on a number of cell interactions by a cell with the first bins and the second bins.

19. The method of claim 18, comprising:
providing, by the processing system, information about the set of bins for the service area affected by the service outage and information about the candidate cells to a machine learning model; and
receiving, by the processing system, from the machine learning model, prediction information for each bin of the set of bins, the prediction information including information about antenna tilts for selected cells of the candidate cells and a predicted signal strength for the bin.

20. The method of claim 16, wherein the determining bin information comprises:
retrieving, by the processing system, information about signal strength detected by user equipment devices operating at a location in the service area associated with a bin; and
retrieving, by the processing system, information a number of signal receptions by user equipment devices operating at the location in the service area associated with a bin.
